(19) United States
(12) Patent Application Publication
(10) Pub. No.: US 2003/0011632 A1
(43) Pub. Date: Jan. 16, 2003

(54) System and method for interactively indicating content preferences

(76) Inventors: Aloke Gupta, Corvallis, OR (US); Donald X. Smith II, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 09/896,011

(22) Filed: Jun. 28, 2001

(51) Int. Cl. G09G 5/00

(52) U.S. Cl. 345/747

(57) ABSTRACT

A system, method, and/or computer readable medium, allows a user to interactively indicate content preferences. An interactive representation of at least of a portion of a document is displayed, such as on a display device. The interactive representation may have a layout substantially the same as a resulting document that would be displayed or printed. The interactive representation includes one or more content areas associated with content item preferences and/or rules for selecting content items to populate the content areas. When a new selection for a content area is made, the interactive representation is automatically updated. Thus, according to an embodiment, the user's view during the interactive process is substantially similar to that of the final document to be produced.

### TECHNICAL FIELD

The present invention is generally related to the field of document formation and, more particularly, is related to a system and method for interactively indicating content preferences for a portion of a document.

### BACKGROUND OF THE INVENTION

The past few years have witnessed the growth of a new type of publication, the electronic publication. Readers of these publications typically sign onto the Internet through their computer, and read the publications online. Some of these publications allow users to state personal preferences on what type of material they want to read. Often, these personalized electronic publications include advertising, usually in the form of a banner ad that is placed on the top of the screen.

While these electronic publications have been an interesting development in the distribution of information, they still represent a tiny fraction of the information that is published. Many readers of these electronic publications complain that they are very difficult to read, especially for long periods of time. While it might be convenient for a reader to sign onto the Internet to look at a news web site for a brief summary of late breaking news, this reader would most likely only spend a few minutes at the site, and would likely still subscribe to the more traditional print media such as Newsweek or the Washington Post. He or she would also likely spend significantly more time reading a more traditional printed publication than the electronic publication, and correspondingly would spend more time being exposed to the ads in the traditional printed publication. Accordingly, printed publications continue to flourish today more than five centuries after mass production of them first became possible.

One avenue of increasing the popularity of electronic publications is to allow a user some choice in the content of the publication, essentially allowing the user to create a personal publication. However, mechanisms for making content choices may be awkward, for example requiring a user to wade through many screens to make choices. In addition, the resulting document may be unsatisfactory, due to the difficulty of generating a sample document during the content choosing process.

### SUMMARY OF THE INVENTION

A system, method, and/or computer readable medium, allows a user to interactively generate content preferences at least of a portion of a document. This includes associating, in a computer, a pick list of potential content preference selections with a content area of the at least a portion of the document and the means for updating an interactive view corresponding to the at least a portion of the document, upon a user's choice of one of the selections from the pick list.

### BRIEF DESCRIPTION OF THE SEVERAL VIEWS OF THE DRAWINGS

In the annexed drawings, which are not necessarily to scale:

FIG. 1 is a block diagram of a document preparation network according to an aspect of the present invention;

FIG. 2 is a drawing of a graphical user interface displayed on a client in the document preparation network of FIG. 1 based upon a web page downloaded from a server in the document preparation network;

FIG. 3 is another drawing of a graphical user interface displayed on a client in the document preparation network of FIG. 1 based upon a web page downloaded from a server in the document preparation network;

FIG. 4 is a flow chart of components/processes in a server in the document preparation network of FIG. 1; and

FIG. 5 is a flow chart of components/processes downloaded from a server to a client and executed in the client in the document preparation network of FIG. 1.

### DETAILED DESCRIPTION OF A PREFERRED EMBODIMENT

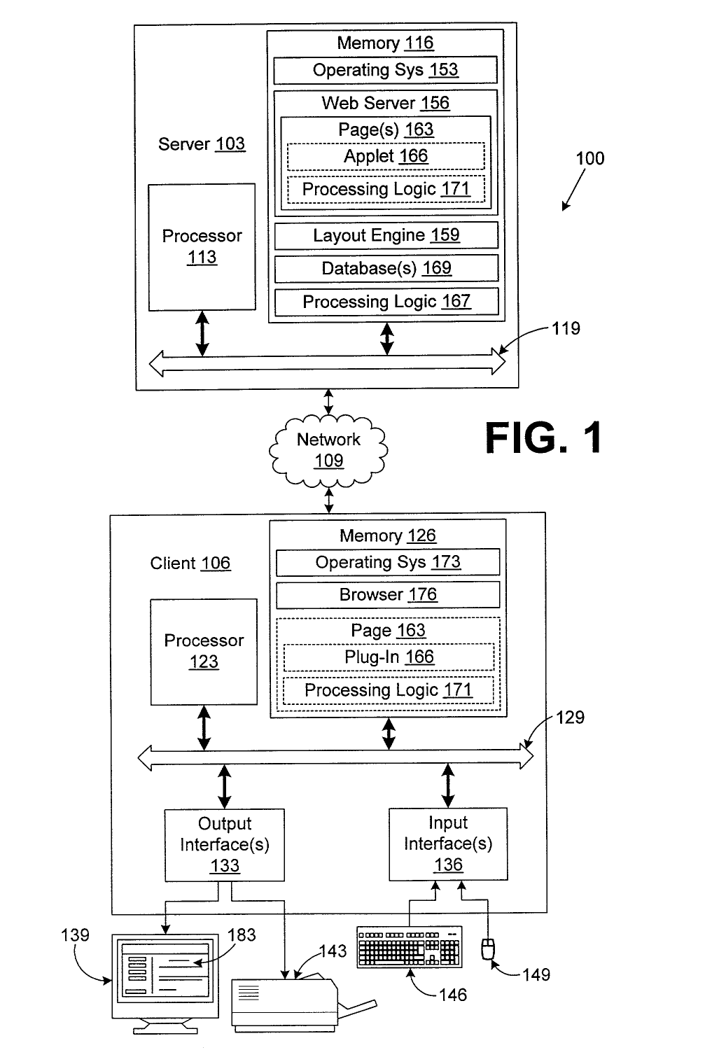

With respect to FIG. 1, shown is a document preparation network 100 according to an aspect of the present invention. The document preparation network 100 includes a server 103 and a client 106, both of which are coupled to a network 109. The server 103 may comprise, for example, a computer system or other apparatus with similar capability. In particular, the server 103 includes a processor circuit with a processor 113 and a memory 116, both of which are coupled to a local interface 119. The local interface 119 may comprise, for example, a data bus with an accompanying control bus, as is generally known by those with ordinary skill in the art.

Various peripheral devices may be employed with the server 103. In particular, peripheral devices to obtain user input may include, for example, a keypad, touch pad, touch screen, microphone, scanner, mouse, joystick, or one or more push buttons, etc. Peripheral devices providing user output may include display devices, indicator lights, speakers, printers, etc. Specific display devices may be, for example, cathode ray tubes (CRT), liquid crystal display screens, gas plasma-based flat panel displays, light emitting diodes, etc.

The client 106 may include, for example, a computer system or other system with similar capability. In particular, the client 106 includes a processor circuit with a processor 123 and a memory 126, both of which are coupled to a local interface 129. The local interface 129 may be, for example, a data bus with an accompanying control bus, as is generally known by those with ordinary skill in the art. The client 106 also includes various output interfaces 133 and input interfaces 136 through which the client 106 may be connected to various peripheral devices. Such peripheral devices may include a display device 139, a printer 143, a keyboard 146, and a mouse 149. Other peripheral devices that may be employed with the client 106 to receive various user input or to provide user output include those listed above with regard to the server 103.

The memories 116 and 126 may include both volatile and nonvolatile memory components. Volatile components are those that do not retain data values upon loss of power. Nonvolatile components are those that retain data upon a loss of power. Thus, the memories 116 and 126 may include, for example, random access memory (RAM), read-only memory (ROM), hard disk drives, floppy disks accessed via an associated floppy disk drive, compact disks accessed via a compact disk drive, magnetic tapes accessed via an appropriate tape drive, and/or other memory components, or a combination of any two or more of these memory components.

In addition, the processors 113 and 123 may represent multiple processors and the memories 116 and 126 may represent multiple memories that operate in parallel. In such a case, the local interfaces 119 and 129 may be an appropriate network that facilitates communication between any two of the multiple processors or between any processor and any of the memories, etc. The local interfaces 119 and 129 may facilitate memory-to-memory communication as well. The processors 113/123, memories 116/126, and local interfaces 119/129 may be electrical or optical in nature. The memories 116 and 126 may be magnetic in nature.

In addition, the network 109 includes, for example, the Internet, wide area networks (WANs), local area networks, or other suitable networks, etc., or any combination of two or more such networks. The server 103 and the client 106 may be coupled to the network 109 to facilitate data communication to and from the network 109 in any one of a number of ways that are generally known by those of ordinary skill in the art. For example, the server 103 and/or the client 106 may be linked to the network 109 through various devices such as, for example, network cards, modems, or other such communications devices.

The server 103 also includes various software components that are stored on the memory 116 and executable by the processor 113. In particular, an operating system 153, a web server 156, and a layout engine 159 all may be stored on the memory 116. The web server 156 includes a number of pages 163. One or more of the pages 163 may include an applet 166 according to an aspect of the present invention. The term “applet,” as used herein, is intended to broadly include programs downloadable onto a recipient machine and executable on that machine. The applet 166, for example, may be written in Java programming language and able to run within a browser on a recipient machine. According to another aspect of the present invention, the memory 116 may include the layout engine 159. The memory includes processing logic 167 for executing document-processing operations. The memory 116 also may include and/or may be linked to one or more databases 169.

In addition, one or more of the pages 163 may include processing logic 171 for performing document-processing operations on the client 106. The processing logic 171 may include the applet 166.

The client 106 also includes a number of software components that are stored on the memory 126 and executable by the processor 123. In particular, the client 106 includes an operating system 173 and a browser 176. By manipulating the browser 176, the pages 163 may be downloaded from the server 103, having been transmitted by the web server 156 stored on the memory 116 of the server 103. Thus, the browser 176 and the web server 156 may operate according to the dictates of the World Wide Web protocol, for example, or other suitable protocol. In this sense, the pages 163 may be considered web pages, although other types of pages or data files may be employed. In one embodiment, the pages 163 may be created using hypertext mark-up language as is generally known by those with ordinary skill in the art. Alternatively, other programming languages may be employed to create the pages 163, including, Java, Active Server Page scripting (ASP), JavaScript, C++, or other suitable computer language.

Both of the operating systems 153 and 173 are executed to control the allocation and usage of hardware resources in the server 103 and the client 106, respectively. Specifically, the operating systems 153 and 173 control the allocation and usage of the memories 116/126, processing time, and the peripheral devices as well as performing other functions. In this manner, the operating systems 153 and 173 serve as the foundation on which applications in the server 103 and the client 106 depend as is generally known by those with ordinary skill in the art.

In addition, the processor 123 in the client may execute the browser 176 to interpret one or more pages 163 downloaded from the server 103. Based on the pages 163, the browser 176 generates corresponding graphical user interfaces (GUIs) 183 on the display device 139 that can be manipulated by the user of the client 106.

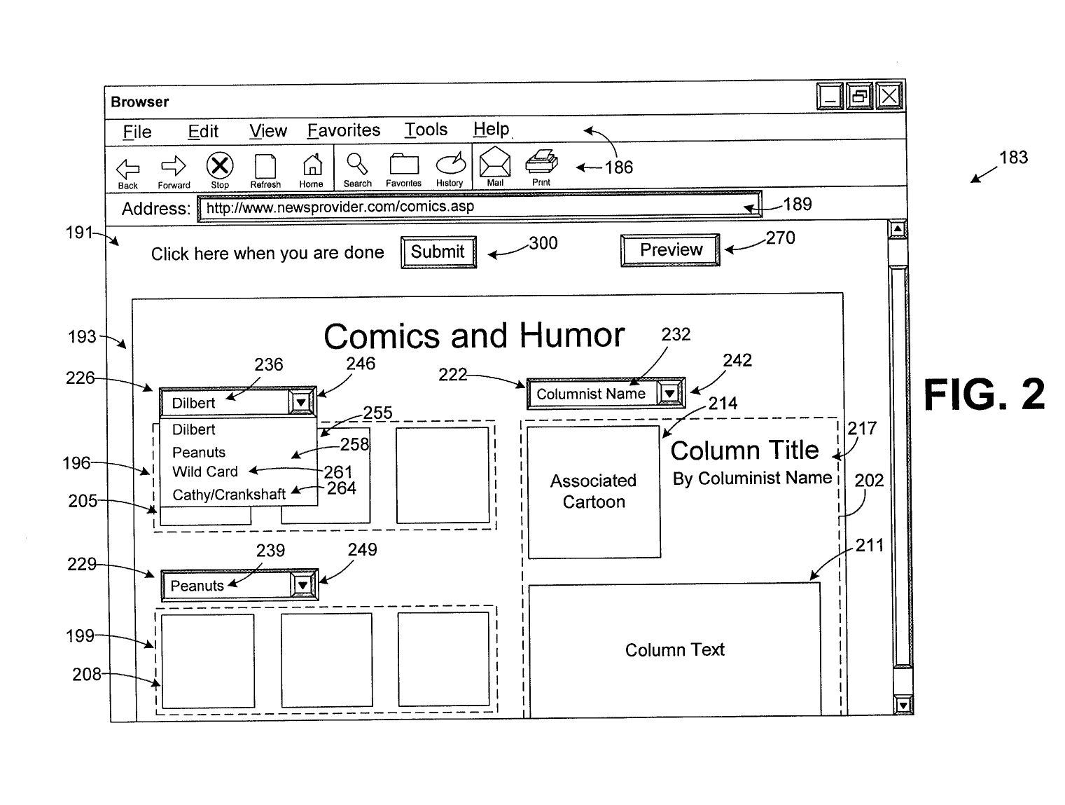

With reference to FIG. 2, shown is a graphical user interface (GUI) 183 according to an aspect of the present invention. The graphical user interface 183 includes various browser components 186 and an address box 189 that may be manipulated to access various web pages 163 (FIG. 1) on various servers 103 (FIG. 1) coupled to the network 109 (FIG. 1). Specifically, a user may enter a uniform resource locator (URL) in the address box 189 to access a specific page 163 located at a specific server 103.

The bottom portion of the GUI 183 displays the page 163 according to an aspect of the present invention. The page 163 includes an interactive document 191 that includes an interactive representation 193 (also referred to as an interactive view) of a document or a portion of a document. The interactive representation 193 is initially populated with content items in specified content areas of the document or portion of a document. The term “content item,” as used herein, broadly encompasses one of multiple instances of a series of image files or text files, for example a single instance of a comic strip series or a single instance of a series of newspaper columns written by a given columnist. The term might refer to a class of items on a general subject, such as baseball-related sports news articles, to give another example. Thus, selection of a content item may be understood to include selection of any of the multiple instances, for example in generally selecting the comic strip series or series of newspaper columns. The initial population of content items may be a fixed set of items for a given type of document. Alternatively, the initial population may be accomplished by initial user selections, made for example from a checklist on an earlier-displayed page. As another alternative, the initial population may be determined based on characteristics of the user, for example based on the user's interests, occupation, preferences in a variety of matters, residence, etc. A wizard may be used in gathering information on the user's interests, etc., and the information may be stored in the databases 169 and/or processes by the processor 113 to determine the initial content of the interactive representation 193

As explained in greater detail below, the interactive representation 193 enables a user to interactively change the type of content items populating the specified content areas in the document or portion of a document, with an updated view of the document or portion being automatically displayed when a change is made. Each content area may have a pick list associated with it, each pick list having a number of selections of possible content items preferences or rules for selecting content items. The pick list may be activated, for example, by clicking on a button in the vicinity of the content area, or by right-clicking on the content area itself. The user then makes one or more selections, as required, from the pick list, and an updated view of the interactive representation 193 is generated. Thus the user is able to view the results of the selections in close to real time, while remaining within the interactive environment that allows further content changes to be made. The process for selecting and arraying content selections is thus facilitated.

The page 163 also includes a proof or print preview mode, which enables the user to see a proof or print preview version of the actual document. The proof version may contain additional portions of the document not displayed in the interactive representation 193, and/or may omit certain components of the interactive representation 193, such as buttons for selecting the pick lists. When the user is satisfied with the content and positions of the content areas in the interactive portion 193, he or she saves the content preferences, such as by pushing a button on the page 163. The proof version may be directed to one or more devices, such as printers, PDAs, computer screens, etc., to enable the user to view an electronic copy or hard copy of the proof version.

The interactive representation 193 includes content areas 196,199, and 202, each populated by one or more content items, which may be examples of content preferences for the content areas. For example the content areas 196 and 199 are populated by comic strips 205 and 208, respectively. The content area 202 is populated by a text column 211, by an associated cartoon 214, and by a column title and columnist name 217.

The content and layout of the interactive representation 193 may be substantially similar to that of a corresponding document or document portion. Thus, although represented schematically in FIG. 2, the content items 205-217 may be images and/or text files of actual sample content items. Also, the positions of the content items 205-217 relative to one another may be substantially the same as in the corresponding document or document portion.

The user may interactively change the content items populating the content areas 196-202, by use of respective pick lists associated with the content areas. Content selection boxes 226, 229, and 232, are associated with the content areas 196, 199, and 202, respectively. The content selection boxes 226-232 have respective content indicators 236, 239, and 242, and have respective pick list actuators 246, 249, and 252. The content indicators 236-242 include an indicator, such as a title or author name, that correspond to the content presently populating the associated content area. The pick list actuators 246-252 may be buttons that activate a pick list such as a pull down menu listing the content preference selections available for the corresponding content area. The pick list actuators 246-252 may be activated using the mouse 149 (FIG. 1), the keyboard 146, or other input device.

It will be appreciated that a wide variety of actuators may be used to activate a pick list corresponding to a content area. For example, as shown in FIG. 2, the pick list may be activated by clicking a button, such as a button located near the content area. Alternatively, the pick list may be activated by right-clicking in the corresponding content area, or by hovering over the content area. Other methods of activating a pick list are known in the art.

The code for activating and displaying the pick lists may be included in an applet 166 downloaded from the server 103 as part of the page 163, and executed by the processor 123 of the client 106.

A pick list 255 corresponding to the content area 196 includes a number of selections 258 for populating the content area 196. The selections 258 may include items in other content areas of the interactive representation 193, allowing the user to rearrange items between the content areas 196-202. Such rearrangement enables the user to select a layout of items that is visually pleasing and/or that enables the user to efficiently browse the content items in a preferred order. The selections 258 may also include other items initially selected by the user as possible preferred content items, which were not displayed in the initial interactive representation 193. In addition, the selections 258 may include content items not selected by the user, for example based on information about the user, or on more general information, such as information on common preferences of the reading public.

The selections 258 may include selections that are not direct selections of a single content item or type of content item. For example, a selection 261 is a “wild card” selection, which indicates a preference for a content item for the corresponding content area 196 to be automatically selected, randomly or otherwise, when the document is composed.

A selection 264 may be a selection that invokes a rule to choose between two or more possible content items for filling the content area 196. For example, the rule may choose one comic strip if the stock market is up, and another comic strip if the stock market is down. It will be appreciated that a wide variety of rules may be constructed for choosing between content items. Such rules may employ information about the user, for example being based on performance of the user's investment portfolio. The rules may employ information about the weather or news stories, for example picking one content item on days with good weather, and another on days with bad weather. Alternatively or in addition, the rule may be based on such factors as the day of the week or the time of day, for example picking one comic strip on Fridays and another on the other days of the week. A rule may involve selecting between different types of content items, for example generating a comic strip if there is no breaking international news, and generating an appropriate news story if there is such news. Rules may involve mathematical and/or logical expressions ranging from the simple to the complex. A selection invoking a rule may cause one of the potential content items to be displayed in the interactive representation 193.

An example rule, involving basing a selection of content items on performance of a user's investment, is illustrated in the following pseudo

code:

if (mystocks-change( ) > 0) then

show DilbertStrip

else

show BornLoser

endif;

A selection may correspond to a single content item, such as for a text file or image file, to be placed in the corresponding content area. Alternatively, a single selection may populate the corresponding content area with several content items. For example, a single selection causes the content area 202 to be populated by a text column 211, by an associated cartoon 214, and by a column title and columnist name 217.

It will be appreciated that a content area may be sized relative to the selections such that more than one content item fits in the content area. Thus the pick list may be arrayed such that multiple selections are made when the pick list is activated. The pick list may include selections of content items of various shapes and sizes, and it will be appreciated that the content items may be placed by appropriate means within a content area of sufficient size to accommodate multiple content items.

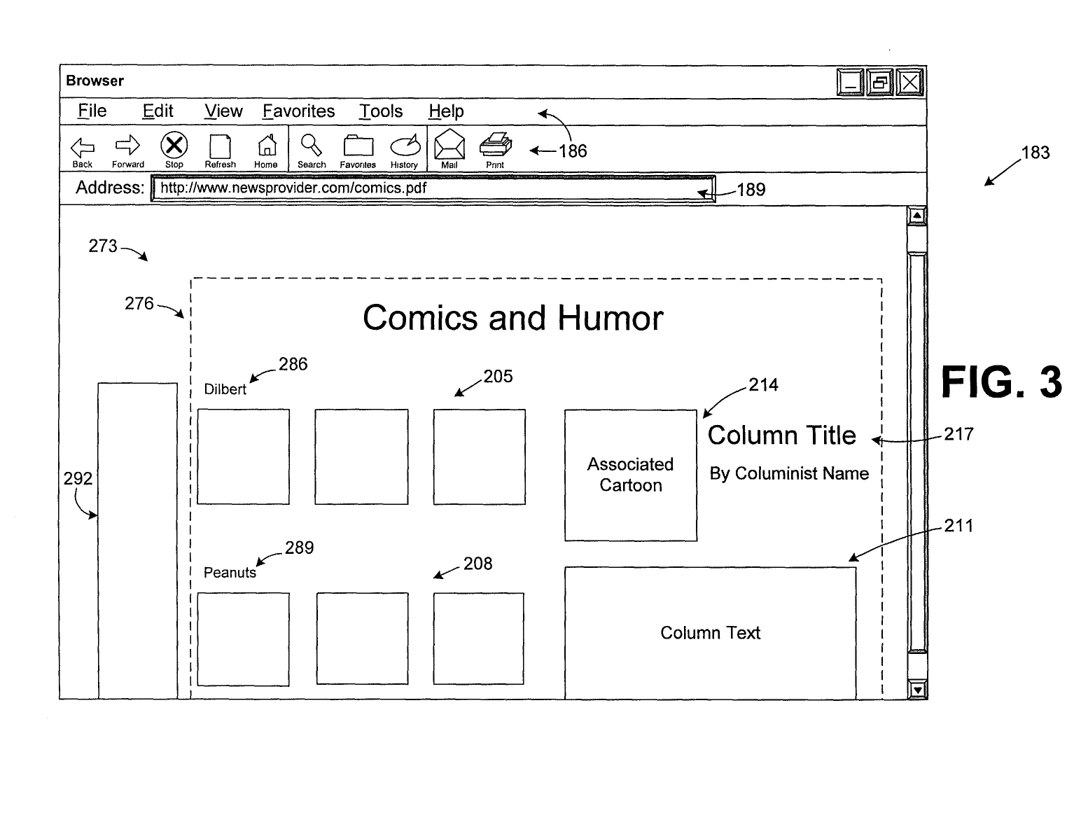

The page 163 includes a preview button 270 that causes a print preview or proof version 273 (FIG. 3) of the document to be displayed. The proof document 273 includes a portion 276 that is a proof version of the interactive representation 193 (FIG. 2). The portion 276 may omit some or all of the items shown in the interactive representation in connection with activation of the pick lists, for example substituting the titles 286 and 289 for the content selection boxes 226 and 229, and omitting the content selection box 232 entirely. The proof document 273 may also include an additional portion 292 that does not correspond to the interactive representation 193. The additional portion 292 may include content, such as advertisements or logos, which are not selectable by the user. However, including the additional portion 292 in the proof document 273 allows the user to obtain a full view of what a sample document with the currently-selected content preferences would look like.

The proof document 273 may be displayed on a display screen, such as on the display device 139 (FIG. 1). Alternatively or in addition, the proof document 273 may be printed, for example to the printer 143, to enable the user to view a hard copy of a sample document with the currently-selected content preferences and layout.

Referring again to FIG. 2, the page 163 also includes an acceptance button 300 to indicate that the currently-selected content items and layout are acceptable, and to conclude the interactive selection process.

With the foregoing discussion in mind, references are made to both FIGS. 1 and 2 to discuss the operation of the document preparation network 100 according to the various embodiments of the present invention. In a first embodiment, a user manipulates the browser 176 to access a web page 163 on the server 103. The page 163 is downloaded to the client 106 and displayed by the browser 176 on the display device 139 as the GUI 183 depicted in FIG. 2. The page 163/GUI 183 provide a system that allows a user to interactively select content for a document or a portion of a document. As shown with respect to FIGS. 2 and 3, the proof document 273 is a comics and humor page, and the interactive representation 193 is a portion of such a page. Note however, that the specific nature of the proof document 273 and the interactive representation 193 could encompass any type of document and are not limited to the document and portion shown in FIGS. 2 and 3, which are merely examples.

Once the page 163 has been downloaded, the user may interactively alter the content populating the content areas 196-202 by activating the corresponding pick list activators 246-252 and making appropriate selections from the appropriate pick lists. In one embodiment, the code for displaying and controlling the pick lists is included in the applet 166 that is part of the page 163, and that is executed by the processor 123. The user chooses one of the selections 258 from the pick list 255 using the mouse 149, the keyboard 146, or other input device. Choosing one of the selections 258 from the pick list 255 causes the interactive representation or view 193 to be updated to reflect the change in the content in the content area 196. The updating of the view may involve sending a message from the client 106 to the server 103, having the layout engine 159 or another part of the server 103 generate all or part of the interactive representation 193 to take account the updated content, with the server 103 then transmitting the full or partial updated interactive representation to the client 106, which then displays the updated interactive representation 193. The server 103 may query the databases 166 to obtain a sample content item corresponding to the selection 258 chosen by the user.

In addition, the user may select to view the proof document 273 by activating the preview button 270, using the mouse 149, the keyboard 146, or other input device. The client 106 then sends a message to the server 103 requesting the proof document. The processing logic 167, utilizing the layout engine 159, generates the proof document 273 and the server 103 transmits it to the client 106, for instance utilizing the same content items as shown in the interactive representation 193. The client 106 displays the proof document 273 on the display device 139 and/or prints the proof document 273 on the printer 143.

When the user is satisfied with the content items assigned to the content areas 196-202, the user activates the acceptance button 300, using the mouse 149, the keyboard 146, or other input device. The client 106 then sends an acceptance or submission message to the server 103, which saves the content preferences associated with the user via the interactive representation 193, such as by saving the preferences in the databases 166.

The user content preferences may then be used for preparing similar documents generated for the user in the future.

The interactive process on the document preparation system has been described above in terms of certain interactions between the server 103 and the client 106. It will be appreciated, however, that the interaction described above is only one example of how such interactions that may be performed. Alternatively, it will be appreciated that the image files for all the possible sample content items insertable in the content areas 196-202 may be sent to the client 106 along with the page 163. In such an embodiment, updating of the interactive representation 193 may take place solely within the client 106. As another alternative, it will be appreciated that other of the processes involved, such as generation of the proof document 273, may be performed solely in the client 106 as well, without the need to interact with the server 103.

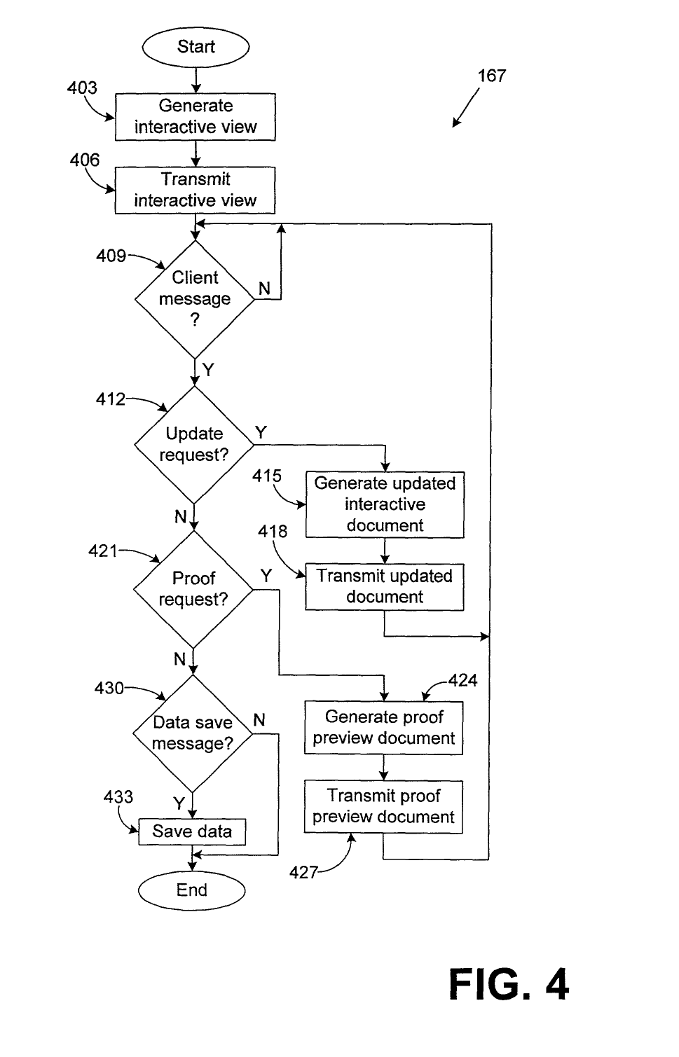

FIG. 4 shows a flow chart of the general functionality (logical functions) of the processing logic 167 (FIG. 1) of the server 103. Alternatively, the flow chart of FIG. 4 may represent the method steps taken in executed by the processing logic 167 of the server 103. In block 403 the server 103 generates the interactive representation of view 193 (FIG. 2) of the document or portion of a document. In generating the interactive representation 193, the server 103 may utilize images and/or text content items from the databases. The interactive representation may be in a mark-up language, such as XML, with the content items referenced as file locations on a storage device and/or as uniform resource locators (URLs) for the files. As discussed above, any of a variety of methods may be used to initially populate the interactive representation 193.

In block 406 the interactive representation 193 is transmitted to the client 106 over the network 109 (FIG. 1), as part of the page 163. In block 409 the server 103 awaits a message from the client 106. When a message is received from the client, the message is examined in block 412 to see if it is a request to update the interactive representation 193. If the message is an update request, in block 415 an updated interactive representation 193 is generated, and in block 415 the updated interactive representation or view is transmitted to the client 106 via the network 109. The updated interactive representation 193 may be transmitted to the client as part of an updated page 163, in which case it is the entire interactive representation 193 that is updated. Alternatively, it may be that only part of the interactive representation 193 is updated and transmitted to the client. In generating the updated view, the processing logic 167 may access content item images, text, or associated data from the databases 166. Following transmission of the updated interactive representation 193 in block 418, the logic 167 returns to block 409 to await further messages from the client 106.

If the message is not an update request, in block 421 the client message is examined to see if it is a request for a proof document such as the proof document 273 (FIG. 3). If so, the proof document 273 is generated in block 424. The generating of the proof document 273 may involve obtaining images and/or text from the databases 166, and using the layout engine 159 to render the proof document in a proper format for display on the display device 139 and/or for printing on the printer 143. Following transmittal of the proof document 273 in block 427, the logic 167 returns to block 409 to await further messages from the client 106.

If the message is not a request for the updated interactive representation 193, or a request for the proof document 273, in block 430 the message is examined to see if it is an acceptance message indicating that the preference data is to be saved. If the message is an acceptance message, in block 433 the user preference data (the choices for populating the content areas, and the content areas with which they are associated) are saved, such as being saved in the databases 166. Alternatively, the preferences may be saved on the client 106, for example as a cookie or as another separate file or part of a file. Otherwise, the processing logic 167 ends accordingly.

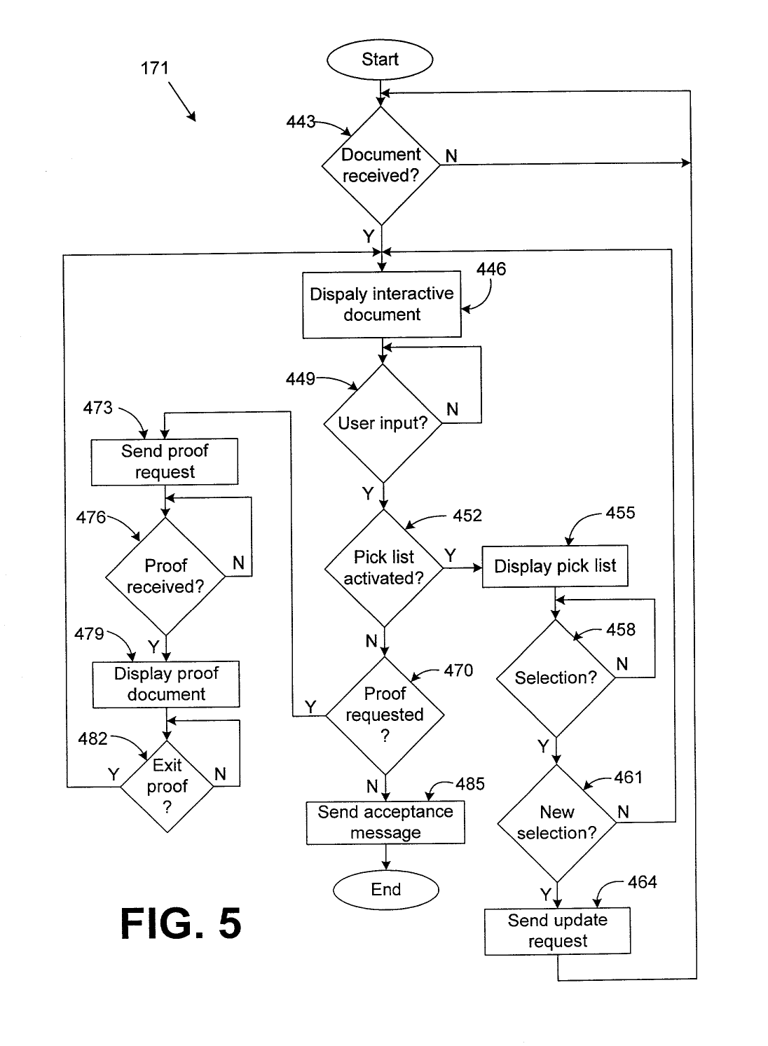

FIG. 5 shows a flow chart of the general functionality (logical functions) of the client processing logic 171 (FIG. 1) in processing the page 163. Alternatively, the flow chart of FIG. 4 may represent the method steps taken in executed by the client processing logic 171. In block 443 the client 106 waits for receipt of the interactive representation or view 193 (FIG. 2) of the document or portion of the document. The initial interactive document is delivered along with the page 163, so that when the page 163 is initially received, the processing logic 171 moves on to block 446, displaying the page 163, including the interactive representation 193.

In block 449 the processing logic 171 waits for user input. Once input is received, if a pick list, such as the pick list 255, is activated in block 452, the processing logic 171 displays the pick list in block 455. In block 458 the processing logic 171 then waits for the user to choose one of the selections 258 from the pick list 255. In block 461 the chosen selection is compared to the prior content item selected for the corresponding content area. If the prior selection and the new selection are the same, there is no need to update the interactive representation 193, and the processing logic 171 reverts to block 446, displaying the interactive representation 193 and the rest of the viewable components of the page 163. On the other hand, if the selection 258 chosen by the user is not the same as the prior content item in the content area corresponding to the pick list 255, in block 464 the processing logic 171 sends an update request to the server 103. The update request is a request for an updated page 163, interactive representation 193, or portion of the interactive representation. The update request may specify the content area needing to be updated, as well as the new content item preference selection for that content area. It will be appreciated that the update request may include additional information besides. Following the sending of the update request in block 464, the client processing logic 171 reverts to block 443, waiting for receipt of the updated page 163, interactive representation 193, or portion of the interactive representation.

The blocks 455-464 may represent functionality of the applet 166 downloaded as part of the page 163 and executed as part of the client processing logic 171. Alternatively, the blocks 455-464 may be method steps undertaken by the applet 166.

If the user input was not activation of a pick list, in block 470 the processing logic 171 checks to see if the user input is a request to display the proof document 273 (FIG. 3). If the proof document 273 has been requested, in block 473 the processing logic 171 sends a proof request to the server 103. Then in block 476 the processing logic 171 awaits receipt of the proof document 273. One received, the proof document 273 is displayed in block 479. Then in block 482 the processing logic 171 awaits the user's exit from the proof document 273. Such exiting may involve the user using the “back” button of the browser 176 to move back to the page 163, with the interactive representation 193, from the proof document 273. After exit of the proof document 273, the processing logic 171 returns to block 446, again displaying the interactive representation 193.

It will be appreciated that the logic involving the proof document 273 may deviate from that shown in FIG. 5 and described above. For example, if the proof document 273 is sent directly to the printer 143 rather than being displayed on the display device 139, then there may be nothing corresponding to blocks corresponding to blocks 476-482. In that case the processing logic 171 may proceed directly from sending the request for the proof document 273, in block 473, to re-displaying the interactive representation in block 446.

Finally, if the user input is activation of the submit button 300 (FIG. 2), in block 485 the processing logic 171 sends an acceptance message to the server 103, instructing the server 103 to save the user's content preferences, and terminating the interactive content selection process.

Although the applet 166 and the processing logic 167 and 171 of the present invention are embodied in software executed by general purpose hardware as discussed above, as an alternative the applet 166 and the processing logic 167 and 171 may also be embodied in dedicated hardware or a combination of software/general purpose hardware and dedicated hardware. If embodied in dedicated hardware, the applet 166 and the processing logic 167 and 171 may be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc. Such technologies are generally well known by those skilled in the art and, consequently, are not described in detail herein.

The flow charts of FIGS. 4 and 5 show the architecture, functionality, and operation of an implementation of the applet 166 and the processing logic 167 and 171. If embodied in software, each block may represent a module, segment, or portion of code that comprises one or more action statements in the form of executable instructions or declarations to implement the specified logical function(s). If embodied in hardware, each block may represent a circuit or a number of interconnected circuits to implement the specified logical function(s). Although the flow charts of FIGS. 4 and 5 show a specific order of execution, it is understood that the order of execution may differ from that which is depicted. For example, the order of execution of two or more blocks may be scrambled relative to the order shown. Also, two or more blocks shown in succession in FIGS. 4 and 5 may be executed concurrently or with partial concurrence. It is understood that all such variations are within the scope of the present invention. Also, the flow charts of FIGS. 4 and 5 are relatively self-explanatory and are understood by those with ordinary skill in the art to the extent that software and/or hardware can be created by one with ordinary skill in the art to carry out the various logical functions as described herein.

Also, the applet 166 and the processing logic 167 and 171 can be embodied in any computer-readable medium for use by or in connection with an instruction execution system such as a computer/processor based system or other system that can fetch or obtain the logic from the computer-readable medium and execute the instructions or action statements contained therein. In the context of this document, a “computer-readable medium” can be any medium that can contain, store, or maintain the applet 166 and the processing logic 167 and 171 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of interactively generating content preferences in at least a portion of a document, comprising:
associating, in a computer, a pick list of potential content preference selections with a content area of the at least a portion of the document; and
updating an interactive view corresponding to the at least a portion of the document, upon a user's choice of one of the selections from the pick list.

2. The method of claim 1, wherein the selections include indications associated with one or more content items that may be placed in the content area.

3. The method of claim 1, wherein the selections include one or more rules for determining one or more content items to be placed in the content area.

4. The method of claim 1, wherein the associating includes associating an applet that includes the pick list, with the content area.

5. The method of claim 1, wherein the updating includes updating only a part of the view corresponding to the at least a portion of the document, leaving other parts of the view not updated.

6. The method of claim 1, further comprising, prior to the updating, displaying the pick list.

7. The method of claim 1, wherein the associating includes associating a pull-down menu that includes the selections, with the content area.

8. The method of claim 1, wherein the updating includes updating a view with a layout which is substantially the same as the at least a portion of the document.

9. A system for generating content preferences for a publication, comprising:
a processor coupled to a local interface;
a memory coupled to the local interface; and
processing logic stored on the memory and executable by the processor, the processing logic including:
logic to associate a pick list of potential content preference selections with a content area of the at least a portion of the document; and
logic to update an interactive view corresponding to the at least a portion of the document, upon a user's choice of one of the selections from the pick list.

10. The system of claim 9, wherein the selections include indications associated with one or more content items that may be placed in the content area.

11. The system of claim 9, wherein the selections include one or more rules for determining one or more content items to be placed in the content area.

12. The system of claim 9, wherein the logic to associate includes logic to associate an applet that includes the pick list, with the content area.

13. The system of claim 9, wherein logic to update includes logic to update updating only a part of the view corresponding to the at least a portion of the document, leaving other parts of the view not updated.

14. The system of claim 9, wherein the processing logic further includes logic to display the pick list.

15. The system of claim 14, wherein logic to display the pick list includes logic to display a pull-down menu.

16. The system of claim 9, wherein the logic to update includes logic to update a view with a layout which is substantially the same as the at least a portion of the document.

17. A computer program embodied in a computer readable medium for generating content preferences for a publication, comprising:
at least one statement for associating a pick list of potential content preference selections with a content area of the at least a portion of the document; and
at least one statement for updating an interactive view corresponding to the at least a portion of the document, upon a user's choice of one of the selections from the pick list.

18. The computer program embodied in the computer readable medium of claim 17, wherein the selections include indications associated with one or more content items that may be placed in the content area.

19. The computer program embodied in the computer readable medium of claim 17, wherein the selections include one or more rules for determining one or more content items to be placed in the content area.

20. The computer program embodied in the computer readable medium of claim 17, wherein the at least one statement for associating includes at least one statement for associating an applet that includes the pick list, with the content area.

21. The computer program embodied in the computer readable medium of claim 17, wherein the at least one statement for updating includes at least one statement for updating only a part of the view corresponding to the at least a portion of the document, leaving other parts of the view not updated.

22. The computer program embodied in the computer readable medium of claim 17, further comprising at least one statement for displaying the pick list.

23. The computer program embodied in the computer readable medium of claim 17, wherein the at least one statement for associating includes at least one statement for associating a pull-down menu that includes the selections, with the content area.

24. The computer program embodied in the computer readable medium of claim 17, where in the at least one statement for updating includes at least one statement for updating a view with a layout which is substantially the same as the at least a portion of the document.

25. A system for generating content preferences for a publication, comprising:
means for associating, in a computer, a pick list of potential content preference selections with a content area of the at least a portion of the document; and
means for updating an interactive view corresponding to the at least a portion of the document, upon a user's choice of one of the selections from the pick list.
